(19) United States
(12) Patent Application Publication
(10) Pub. No.: US 2019/0283273 A1
(43) Pub. Date: Sep. 19, 2019

(54) MAKING AN ARTICLE BY A CASTING METHOD USING A PHOTOACTIVABLE PREPOLYMER

(71) Applicant: Stuart URAM, New York, NY (US)

(72) Inventor: Stuart URAM, New York, NY (US)

(21) Appl. No.: 16/356,305

(22) Filed: Mar. 18, 2019

Related U.S. Application Data
(60) Provisional application No. 62/644,242, filed on Mar. 16, 2018.

(51) Int. Cl. B28B 7/34; B28B 1/14; B28B 7/36

(52) U.S. Cl. CPC B28B 7/34; B28B 7/36; B28B 1/14

(57) ABSTRACT

Provided is a method for forming a ceramic article, including disposing a slurry in a mold, wherein the slurry includes a ceramic powder and a photoctivable pre-polymer; and forming a green ceramic article wherein forming includes exposing the slurry to radiant energy, such as ultraviolet radiation, wherein the radiant energy catalyzes polymerization of the prepolymer. In another aspect, provided is method for forming an article, including disposing a slurry in a mold, wherein the slurry includes a photoactivable pre-polymer and a powder and the powder includes a ceramic powder, a metal powder, or both; and exposing the slurry to ultraviolet radiation wherein the ultraviolet radiation catalyzes polymerization of the pre-polymer.

### CROSS-REFERENCE TO RELATED APPLICATIONS

This application claims the benefit under 35 U.S.C. § 119(e) of U.S. Provisional Patent Application Ser. No. 62/644,242, filed on Mar. 16, 2018, the content of which is incorporated by reference herein in its entirety.

### FIELD OF INVENTION

The present disclosure relates to the field of forming articles by a casting method. More particularly, it relates to a method of forming articles including exposing a slurry in a mold to radiant energy to form a green ceramic article or other article.

### BACKGROUND OF THE INVENTION

Articles may be constructed from ceramic powders for numerous applications, such as to form a ceramic core for subsequent use in different casting applications. In order to form parts in a closed mold from a slurry, the material must be hardened either by drying as in slip casting or chemical reaction as in plaster molding or by gelcasting where gel is formed. All of these processes suffer from various technical problems. In the case of slip casting, a long time is required to remove the water so the part is able to be removed from the mold. In addition, the slurry composition must be designed to be stable so the particles do not fall out of the slurry during this step. The part geometry is limited because the mold must be opened to remove the part for final drying and firing.

A ceramic core may itself be formed by a gelcasting process. Gelcasting includes setting up a slurry including a ceramic powder or particles in a mold to form a green ceramic article, followed by removal of the green ceramic articles from the mold. The part may be formed by a chemical reaction, but it is difficult to form a strong gel in many types of slurries and esoteric chemicals are often employed to create the gel. In many instances, a green ceramic article may be relatively weak and susceptible to physical disruption upon removal from a mold, leading to deformation or destruction of the green ceramic article upon removal from the mold. Also, the time it takes a ceramic slurry to form a green ceramic article in a mold may be of long or uncertain duration, in which case an attempt to remove an article expected or believed to be a green ceramic article may lead to deformation or destruction of the article because it had incompletely set when removal was attempted. There is a time constraint for gelcasting or setting by chemical reaction. Once the material is mixed, it must be poured into the mold before it sets. Moreover, it is not possible to dry the part without destroying the mold. The design must be limited so that the mold can be opened. Thus, there is a need for an improved method for setting up a green ceramic article in gelcasting processes.

Furthermore, it may be difficult to remove a mold from a green ceramic article, either because the mold is too strong such that removal of the mold from the green ceramic article requires exertion of excessive physical force leading to deformation or destruction of the green ceramic article, or because the mold and the outer surface of the green ceramic article have become adhered to each other during setting of the green ceramic article such that separation of the one from the other is too difficult, requiring a degree of physical force that causes the deformation or destruction of the green ceramic article.

3-D printing may provide a limited solution to the above-discussed problems as the part does not need to be removed from the mold. However, 3-D printing is limited by the size and distribution of the particles as well as viscosity. In order to print fine detail, for example, 50 microns, no particle typically can be greater than 50 microns. So traditional particle packing with large particles is not possible. Additionally, traditional particle packing with varying sized particles is not practical. A further limitation is viscosity since the slurry must flow across the build plate surface. If a thick part or very tall part is built, it may slump under its own weight. Another potential problem is that the printed part is not isotropic. Properties at right angle to layers may not be the same as properties within the layer that are horizontal to the build direction.

Range of liquid resin may be from a low of 10 volume per cent which will yield a very viscous, mud like slurry, to 50 volume per cent that will yield a very thin slurry and result in an open porous final part. The resin could be diluted with alcohol up to 60 volume per cent and still act as a binder although the green strength will be reduced but the burnout characteristics will be improved. Water containing ultraviolet (UV) resins are available and will normally result in a very weak green strength. Accordingly, their use in conventional 3-D printing is problematic.

Similar processes, and shortcomings, may be used for forming articles other than ceramics, from powders other than ceramic powders. For example, metal powders may be formed into articles using a gelcasting technique, and many of the foregoing difficulties encountered in forming green ceramic articles may likewise be encountered in forming articles from slurries including metal powders. Thus, there is a need for an improved method of removing a mold from a green ceramic article, or articles made from a slurry containing a non-ceramic component such as a metal powder in gelcasting processes.

### SUMMARY OF THE INVENTION

The shortcomings of the prior art are overcome, and additional advantages are provided, through the provision, in one aspect, of a method for forming a ceramic article, including disposing a slurry in a mold, wherein the slurry includes a ceramic powder or particles and a photoctivable pre-polymer; and forming a green ceramic article wherein forming includes exposing the slurry to radiant energy, wherein the radiant energy catalyzes polymerization of the pre-polymer. In some embodiments, the radiant energy includes a wavelength and the wavelength may be selected from the group including radiofrequency, microwave, infrared, visible, ultraviolet, X-rays, and gamma rays. In an example, the radiant energy may include ultraviolet radiation.

In some embodiments, exposing may occur until the slurry attains a hardness and the hardness is the maximum hardness that can be caused by exposure to the radiant energy. In other embodiments, the material of the mold may be at least partially transparent to the radiant energy. In still further embodiments, the mold may include one or more openings and the radiant energy passes through one or more of the one or more openings. In other embodiments, the mold may include a material selected from the group including acrylonitrile butadiene styrene and polylactic acid.

In yet further embodiments, the green ceramic article may be sintered. In some examples, the green ceramic article may be removed from the mold before sintering. In other embodiments, sintering the green ceramic article may include removing the mold from the ceramic article during sintering. In still other embodiments, disposing includes multistage slip pouring. Some examples include altering the composition of the slurry between stages of a process of multi-stage slip pouring. In still further examples, the slurry includes a coarseness and the coarseness of the slurry disposed at an earlier stage of the process of multi-stage slip pouring is less than the coarseness of the slurry at a later stage of the process of multi-stage slip pouring.

In yet another embodiment, the method includes disposing a mold coating on the mold. In some examples, disposing the mold coating includes chemical vapor deposition or vapor phase deposition. In still other embodiments, the method includes manufacturing a mold and manufacturing the mold includes additive manufacturing.

In another aspect, provided is method for forming an article, including disposing a slurry in a mold, wherein the slurry includes a photoactivable pre-polymer and a powder and the powder includes a ceramic powder, a metal powder, or both; and exposing the slurry to ultraviolet radiation wherein the ultraviolet radiation catalyzes polymerization of the pre-polymer. In some embodiments, the mold includes material that is at least partially transparent to the ultraviolet radiation. In some examples, the mold includes acrylonitrile butadiene styrene. Some embodiments further include removing the mold from the article by contacting the mold with a compound that dissolves the mold but does not dissolve the article.

These and other features of the present invention are described in, or are apparent from the following detailed description of various exemplary embodiments of the invention.

### BRIEF DESCRIPTION OF THE DRAWINGS

One or more aspects of the present disclosure are particularly pointed out and distinctly claimed as examples in the claims at the conclusion of the specification. The foregoing and other objects, features, and advantages of the present disclosure are apparent from the following detailed description taken in conjunction with the accompanying drawings in which:

FIG. 1 is a flow diagram for a method of forming a ceramic article in accordance with aspects of the present disclosure;

FIG. 2 is an illustration of a method of forming a ceramic article in accordance with aspects of the present disclosure;

FIG. 3 is an illustration of another example of forming a ceramic article in accordance with the present disclosure;

FIG. 4 is an illustration of yet another example of forming a ceramic article in accordance with the present disclosure;

FIG. 5 is a flow diagram for an embodiment of a method of forming a ceramic article, including additively manufacturing a mold, in accordance with aspects of the present disclosure;

FIG. 6 is a flow diagram for an embodiment of a method of forming a ceramic article, including sintering, in accordance with aspects of the present disclosure;

FIG. 7 is a flow diagram for another embodiment of a method of forming a ceramic article, including sintering, in accordance with aspects of the present disclosure; and

FIG. 8 is a top view of an exemplary article formed in accordance with an exemplary embodiment of the present invention.

### DETAILED DESCRIPTION OF PREFERRED EMBODIMENTS

Aspects of the present disclosure and certain features, advantages, and details thereof, are explained more fully below with reference to the non-limiting embodiments illustrated in the accompanying drawings. Descriptions of well-known materials, fabrication tools, processing techniques, etc., are omitted so as to not unnecessarily obscure the aspects of the present disclosure in detail. It should be understood, however, that the detailed description and the specific examples, while indicating embodiments of the disclosure, are given by way of illustration only, and are not by way of limitation. Various substitutions, modifications, additions and/or arrangements within the spirit and/or scope of the underlying inventive concepts will be apparent to those skilled in the art from this disclosure.

Disclosed herein is a method for forming a ceramic article. One general method of forming a ceramic article is referred to as gelcasting. In this method, a liquid or semi-liquid material known as a slurry is poured into a mold and allowed to set. A slurry may contain various substituents including a liquid carrier, ceramic particles or ceramic powder, and a binder. A mold is a pre-formed solid structure with an interior space or cavity to be filled, partially or fully, by the slurry. The mold's interior space is conformed around the shape which the green ceramic article is intended to have when set. After the slurry is disposed in the mold, it is allowed to set, forming a green ceramic article.

After setting, the green ceramic article may be removed from the mold, or the mold may be removed from the green ceramic article. A green ceramic article may then be further processed to form a final ceramic article. For example, the green ceramic article may be heated, sintered, or otherwise processed to harden or fuse its components to each other, yielding a ceramic article that may have a greater physical hardness and strength that possessed by the green ceramic article before heating, sintering, etc. But the process of detaching a green ceramic article and a mold from each other may pose difficulties. It may be difficult to determine whether a green ceramic article has set sufficiently to withstand any physical shear or stress forces that may be applied in order to remove the mold. Also, even a fully set green ceramic article may possess vulnerabilities in its physical structure that render it susceptible to deformation or destruction upon attempts to remove a mold. Furthermore, a green article may simply take too long to fully et, wherein an accelerated setting process would improve efficiency of the gelcasting process.

As disclosed herein, a process of setting a green ceramic article, as an aspect of forming a ceramic article, such as a ceramic core, wear-resistant parts, parts for use in high temperature applications, high-performance structural parts, or porcelain pieces such as china or other decorative items, as non-mutually exclusive and non-limiting examples, may be improved by including as a constituent of a slurry a photoactivable pre-polymer. A slurry may include ceramic powder such as fused silica, silicon carbide, alumina, zirconia, clay, feldspar, or composite materials, as non-limiting examples.

Also included in a method disclosed herein is forming an article from a slurry wherein the slurry includes a powder other than or in addition to a ceramic powder and a photoactivable pre-polymer. For example, a slurry may contain a metallic powder, for use in casting, for example, a metal part, or a porous metal part that may be infiltrated with another material. A metal powder may include steel powder, stainless steel powder, copper alloy powder, titanium powder, or any combination of two or more of the foregoing, as nonmutually exclusive and non-limiting examples. An advantage of forming a part from a slurry containing a metal powder in accordance with the present disclosure is that large powder or particle sizes may be part of the formulation of a slurry instead of or in addition to fine particles. Such formulations may, for example, advantageously reduce costs, improve the ability to gain a high density of a finished part, or both. For example, in an metal injection molding process it may be necessary to use very fine metal particles to obtain flowability and to be able to sinter the “green” or “unfired” piece to a high density. Fine metal particles, such as those less than 100 microns in diameter, are expensive and may be troublesome to use. Such disadvantages could be overcome by a method disclosed herein, where a slurry containing metal particles or metal powder, some or all of which may be larger than 100 microns in diameter, and a photoactivable pre-polymer, may be used to form an article.

In other examples a slurry used to make an article may contain plastic particles or plastic powder. For example, plastic particles or plastic powder may include a polyolefin, such as polyethylene or polypropylene, or others such a polyvinyl chloride, polystyrene, styrene-acrylonitrile, acrylonitrile butadiene styrene, polycarbonate, nylon or other polyamide, or combinations of two or more of the foregoing, as non-limiting examples. A slurry may include a plastic powder and a photoactivable pre-polymer for formation of an article in accordance with a method disclosed herein.

A photoactivable pre-polymer is a substance containing monomers that may form a polymer in response to stimulation from a source of radiant energy. In some examples, a photoactivable pre-polymer may include monomers that will not covalently bond to one another to form a polymer in the absence of exposure to a type of radiant energy. In other examples, the monomers, or other components of the photoactivable pre-polymer, might eventually covalently bind to one another in the absence of exposure to a given type of radiant energy, but would do so extremely slowly or only at negligible or barely detectable levels over the course of minutes or hours but may do so much more quickly and detectably when exposed to said radiant energy.

When slurry contains a photoactivable pre-polymer, it may be poured into a mold but not set to form a green ceramic article over a short time frame of minutes, several hours, or overnight, depending on the complement of substituents contained in the slurry, in the absence of exposure to a given form, type, intensity, frequency, or quantity of radiant energy, but upon exposure thereto it may set quickly to form a green ceramic article, such as within minutes or hours. Depending on the type of photoactivable pre-polymer, and the specifications of radiant energy required to catalyze polymerization thereof and coincident formation of a green ceramic article, conditions of radiant energy exposure may be set so as to control a rate of green ceramic article formation such that a green ceramic article will form sooner than it would have in the absence of radiant energy exposure yet not until a predetermined, desirable time frame. For example, conditions for radiant energy exposure, for a slurry containing a given photoactivable pre-polymer, may be employed such that for a given mold configuration, radiant energy exposure of a specific number of minutes, or a specific number of hours, may lead to a degree of polymerization as to form a green ceramic article of desired hardness and desired homogeneity. In embodiments, the type of photoactivable pre-polymer for use in a slurry may be selected by matching with a desired frequency or a desired range of frequencies of radiation for polymerizing the pre-polymer. In embodiments, one may choose the type of photoactivable pre-polymer that is polymerized by a specific frequency of radiation that is outside the range of visible spectrum. In this case, one can view the process using visible light (e.g., to operate the machinery) without risking premature curing of the slurry.

In other examples, a photoactivable photopolymer may be selected and parameters of radiant energy exposure employed such that as complete a degree and homogeneity of hardness of a green ceramic article may be attained quickly, on the order of minutes or hours, or even more quickly. Radiant energy exposure may also continue beyond a point at which accumulated radiant energy exposure has catalyzed as much polymerization as possible such that continued radiant energy exposure is merely incidental and causes no further hardening of the green ceramic article. In some examples, other processes, such as hardening processes that occur irrespective of radiant energy exposure, or irrespective of exposure to a type, frequency, or intensity of radiant energy employed for the purpose of catalyzing polymerization of the photoactivable pre-polymer, may continue in parallel with, before, and/or after completion of radiant energy-exposure catalyzed polymerization of a photoactivable pre-polymer.

Using a slurry that includes a photoactivable pre-polymer to form a green ceramic article may have numerous advantages. For example, for some photoactivable prepolymers, no or negligible polymerization may occur in the absence of exposure to a catalyzing radiant energy. In such circumstances, a time frame of disposing a slurry in a mold may be lengthened without undesirable consequences. For example, slurries that lack a photoactivable pre-polymer may begin to harden very quickly, even immediately upon beginning to be disposed in a mold or perhaps even before then. In such cases, a uniform dispersion of slurry components within a mold may be difficult to attain, leading to inhomogeneities in a resultant green ceramic article. In extreme cases, this may result in a green ceramic article that does not set completely, or sets at an inhomogeneous rate, such that some portions become relatively hardened at a time when other portions have not, whereupon attempts to remove the green ceramic article from the mold may disrupt such portions as have not yet fully set.

In contrast, with a slurry containing a photoactivable prepolymer, hardening into a green ceramic part may be induced to occur quickly, or at a predetermined rate, and in a relatively homogeneous manner, or to a degree of hardness that is relatively homogeneous in a final green ceramic article. In some examples, a mold may be configured such that a green ceramic article when formed therein will contain fine, intricate, and/or complex topologies that may be susceptible to deformation, breakage, or destruction upon removal of the mold after green ceramic article formation. When it is difficult to determine whether homogeneous or complete hardness of a slurry has occurred, or if a degree of hardness beyond which no further degree of hardness may be obtained without inclusion of a photoactivable pre-polymer in a slurry and exposure to catalyzing radiant energy, removing a green ceramic article from a mold may result in breakage, deformation, or destruction of said green ceramic article or portions thereof. In accordance with aspects of the present disclosure, inclusion of a photoactivable pre-polymer and subsequent exposure to catalyzing radiant energy may promote formation of a ceramic green article of sufficient hardness and hardness of sufficient homogeneity such that removal of the mold does not or is less likely to damage, deform, or destroy the green ceramic article or regions of delicate or complex topology thereof.

Another difficulty in forming a green ceramic article that begins to harden from a slurry without any catalyzing effect of exposure to radiant energy is that air bubbles may form and be trapped within portions of the slurry that harden. Formation of such air bubbles may lead to air pockets in the body of or deformity of a resulting ceramic article, or may result in fragility due to lack of ceramic material within the body of the ceramic article. Various methods for removing air bubbles from a slurry, whether before, during, and/or after it is disposed in a mold, may be employed to prevent such air bubbles or pockets being incorporated into a resulting ceramic article. Examples include palpating or shaking the slurry, rotating the slurry, or applying vacuum pressure to the slurry to draw air bubbles out to the surface. However, for slurries that begin to harden into a green ceramic article without catalysis by a radiant energy, such methods may be of limited use, or applicable only during a brief window, after which the slurry may have hardened to such an extent or degree that use of such methods is no longer effective at removing air bubbles.

In contrast, including a photoactivable pre-polymer in a slurry may provide a level of temporal control over hardening and green ceramic article formation and extension of a time period during which methods to remove air bubbles may be successfully performed. For example, a slurry containing a photoactivable pre-polymer may remain in an unhardened state for a prolonged period of time, prior to exposure to catalyzing radiant energy, allowing for extension of the period of time of palpating, shaking, or rotating the slurry, or exposing it to vacuum pressure, before, during, and/or after the slurry is disposed in a mold employed to remove air bubbles, followed by exposure to catalyzing radiant energy, resulting in reduced or minimized risk that the resulting green ceramic article contains air bubbles.

Any of a widely known variety of ceramic powders or particles may be used in a slurry in accordance with the present disclosure. For example, ceramic components of a slurry may include any type of alumina ceramic particles, such as fused alumina particles, calcined alumina, tabular alumina, or any combinations thereof. Other ceramic components may also be used, including zirconia ceramic particles, or traditional porcelain ceramic particles such as those including clay mixed with feldspar, silica, other porcelain additives, and any combinations of the foregoing.

A slurry may contain a resin as a liquid carrier. Furthermore, in some examples a photoactivable pre-polymer in a slurry may be a resin. Thus, in some examples, the carrier in a slurry may include a photoactivable pre-polymer resin. Depending on desired characteristics of a green ceramic article to be produced, various amounts of ceramic particles may be added to a carrier, such as a resin or a photoactivable pre-polymer resin, to form a slurry. In some examples, ceramic loading of a slurry in a carrier may be as low as 15 per cent by weight, or as high as 80 per cent by weight, or at any desired per cent by weight ceramic loading as is desired for a given application. In some examples, a low per cent by weight of ceramic loading of a slurry may be used, because radiant energy-catalysis of polymerization of a photoactivable pre-polymer may lead to sufficient hardness of a green ceramic article even where ratio of ceramic constituent to carrier is lower than would conventionally permit formation of a sufficiently hard green ceramic article or one of sufficiently homogeneous hardness.

Ceramic loading may be between 15 to 20 per cent, 20 to 25 per cent, 25 to 20 per cent, 30 to 35 per cent, 35 to 40 per cent, 40 to 45 per cent, 45 to 50 per cent, 50 to 55 per cent, 55 to 60 per cent, 60 to 65 per cent, 65 to 70 per cent, 70 to 75 per cent, or 75 y 80 per cent by weight. In other examples, ceramic loading may be between 15 to 25 per cent, 25 to 35 per cent, 35 to 45 per cent, 45 to 55 per cent, 55 to 65 per cent, 65 to 75 per cent, or over 75 per cent by weight. In still other examples ceramic loading of a slurry may be between 15 and 30 per cent, 30 and 45 per cent, 45 and 60 per cent, 60 and 75 per cent, 65 and 80 per cent, 50 and 65 per cent, 35 and 50 per cent, 20 and 35 per cent, or below 20 per cent by weight.

In some examples, a photoactivable pre-polymer resin may be included in the slurry, such that exposure of the slurry to a catalyzing radiant energy after the slurry is disposed in a mold causes the resin to set and hardening of the green ceramic article. Subsequently, the resin may be removed from the green ceramic article, such as by exposure to high heat. Heating and melting or burning away a set resin after polymerization by exposure to catalyzing radiant energy removes resin from the green ceramic article, such that resin components would not be present following final processing of the article and formation of a sintered or final ceramic article. It is therefore possible to use a resin, including a photoactivable pre-polymer resin, for formation of a green ceramic article even when inclusion of resin constituents in the final ceramic article is undesirable.

A variety of photoactivable pre-polymers are commercially available and would be well-known to skilled artisans. A photoactivable pre-polymer may contain various monomers, oligomers, and photoinitiators that harden upon exposure to a given type of radiant energy. For example, a photoactivable pre-polymer may include various acrylates, such as methacrylate esters, and photoinitiators, such as benzophenone, xanthones, quinones, benzoin ethers, acetophenones, benzoyl oximes, and acylphosphines, may be used, to give a few non-limiting examples. Photoactivable pre-polymers are especially well known for use in additive manufacturing, and resins in wide use for such processes, such as 3D printing, may be particularly appropriate. Numerous commercial vendors of such photoactivable prepolymeric resins are known in the relevant technical field, such as FORMLABS, SARTOMER, and BASF, to name a few.

Any type of radiant energy which is responsible for catalyzing polymerization of a photoactivable pre-polymer may be used for setting a slurry in accordance with the present disclosure. In some examples, electromagnetic radiation of an ultraviolet wavelength may be used, where the photoactivable pre-polymer is polymerized when exposed to such energy. Other examples may include use of other wavelengths of electromagnetic radiation, such as radiofrequency, microwave, infrared, visible, X-rays, gamma rays, or any combination of such wavelengths where such wavelength or combination is effective in catalyzing polymerization of the photoactivable pre-polymer included in the slurry. A duration of exposure may also be varied depending on the time frame over which setting of the green ceramic article is desired to occur.

A mold may be designed in such a way as to permit exposure to a source of radiant energy external to the mold to catalyze polymerization of a photoactivable prepolymer component of a slurry contained within the mold. In some examples, the mold may be constructed of a material which is transparent, whether partially or completely, to a wavelength of electromagnetic radiation that catalyzes polymerization. In that way, though a slurry containing a photoactivable pre-polymer whose polymerization may be catalyzed by a given wavelength of electromagnetic radiation may be so catalyzed though the source of radiation is located outside the mold while the slurry is located within the mold, with the material of the mold being present between the radiation source and the slurry. In other examples, pores, holes, or openings may be present in the mold such that radiation emanating from a source located outside the mold may access the slurry within the mold and catalyze polymerization of the photoactivable pre-polymer located therein. In yet another examples, the thickness of the mold may be designed to vary in different places so as to allow radiation emanating from a source located outside the mold to access the slurry within the mold through thinner portions of the mold (e.g., dimples).

After formation of a green ceramic article, a mold may be removed by being manually pulled off the green ceramic article. In other examples, the mold may be constructed of materials that may be removable by exposure to heat, so as to be melted or burned off of the green ceramic article. In such examples, after setting of the green ceramic article by exposure to catalyzing radiant energy, the green ceramic article and mold in which it is contained may be exposed to heat sufficient to melt or burn away most or all of the mold material, leaving only or predominantly the green ceramic article. In some examples, a mold may be melted or burned off of a green ceramic article at a lower temperature that the green ceramic article may be exposed to in a sintering process, by which the green ceramic article is transformed into a final ceramic article. In other examples, the mold may be melted or burned away by exposure to a high sintering temperature, such that mold removal and sintering occur in one step. In yet other examples, a resin may be burned away during wither or both of these processes, or in a separate process, before or after removal of the mold.

In embodiments, a water soluble mold made of a semi-transparent material may be used. In embodiments, such a mold may be formed by 3-D printing. An advantage of using a water soluble mold is that if the unfired piece is not water soluble, it is easy to remove the mold from, for example, a delicate piece such that the unfired piece remains strong after the removal of the mold.

As would be evident to skilled artisans in the relevant field, where aspects of the foregoing, or following, disclosure describe or refer to inclusion of a ceramic particle or powder in a slurry or formation of a ceramic article or green ceramic article, such disclosure could be modified to accommodate inclusion of a metal particle or powder in a slurry or formation of a metal article or unfired “green” metal article. Such modifications and examples are explicitly included herein as aspects in accordance with the present disclosure.

A mold may be composed of any suitable material. Non-limiting examples of a material of which a mold may be made include acrylonitrile butadiene styrene (ABS) and polylactic acid. In some examples, a mold may be composed of a material that dissolves when exposed to a given chemical or solvent, and the green ceramic article may not dissolve in said chemical or solvent. For example, the mold may be made of ABS, which can be dissolved away from a green ceramic article by submersion in acetone yet leave a green ceramic article intact. Other possible examples of suitable mold component material and chemical or solvent in which it can or would dissolve without affecting a green ceramic article would be evident to skilled artisans and such examples are explicitly included within the scope of the present disclosure.

In some examples, a mold may be manufactured by an additive manufacturing process, such as 3D printing. An additive manufacturing process includes a successive series of steps in which layers of an article are formed by deposition or accumulation of material at specified points then their hardening catalyzed by the application of energy, such as a laser focused on specific points where additional material is intended to be added to the article as it is being manufactured. Additive manufacturing such as 3D printing may be visualized as a process whereby thin cross-sections of an article are successively added to build the article cross-section by cross-section, or layer by layer. 3D printing and other additive manufacturing processes permit wide flexibility in the topography of an article that may be manufactured thereby, aided by computer assisted drawing methods where the topology of the article is represented in a computer file and that 3D representation is translated by a computer into instructions to an energy source, such as a laser, that is used to add successive layers of material to an article as it is being manufactured.

For example, energy such as ultraviolet or other radiation energy may be applied to a portion or portions of a surface of a newly formed or forming article where said newly formed or forming article contacts a prepolymer and polymerization of the prepolymer is catalyzed, at said portion, by the ultraviolet or other radiation or energy applied thereto. The energy may be applied by, for example, a laser or ion beam source and the portion of a surface of a newly formed or forming article, where it contacts said prepolymer, to which the ultraviolet or other radiation or energy is applied by said laser or ion beam source may be determined by said computer, thereby adding a successive cross-sections or layers to the newly formed or forming article at said specific portion. In accordance with aspects of the present disclosure, a mold may be manufactured by additive manufacturing or 3D printing, which may allow for complex topology of the cavity within the mold and consequently complex topology of a green ceramic article formed therein. Additive manufacturing such as 3D printing may also be used to create molds with simpler, less complex topology.

In some examples it may be desirable to facilitate removal of a mold from a green ceramic or other article by applying a coating to the inner surface of the mold before the slurry is disposed therein. A coating may facilitate the process by which the mold is removed, whether manually or by being melted or burned off, after setting of the green ceramic or other article. Any coating that promotes separation of the inner surface of the mold from the outer surface of the green ceramic or other article after formation thereof may be added to the inner surface of the mold. Various processes well known to skilled artisans could be employed for this purpose. As non-limiting examples, included are chemical vapor deposition and vapor phase deposition.

In other examples, a multi-stage process of slip-casting may be used, in accordance with aspects of the present disclosure. Slip casting may include pouring a slurry into a mold for a brief period of time to permit portions of the slurry in contact with the mold to begin to solidify slightly, such as through absorption of moisture from the carrier into the mold. Slurry that remains unhardened may then be poured out of the mold, leaving the partially hardened or solidified portion in the mold. In a multi-stage process of slip casting, successive stages of adding slurry to the mold, allowing its outer boundary in contact with a portion of the mold, or a previously deposited layer of partially hardened or solidified slurry thereon, to slightly solidify or harden before the remainder of the slurry added during that stage from being poured out. With each stage of a multi-stage slip-casting process, slurry added during each sage may optionally have different characteristics from slurry disposed in the mold during a different stage. For example, the amount or ratio of ceramic material relative to carrier may be varied, or the amount or ratio of photoactivable pre-polymer relative to other components may be varied from slurry used in one stage to another. In some examples, coarseness, or ratio of ceramic particle to carrier, may be higher in an earlier stage of a multi-stage slip casting process than the coarseness of slurry used during a later stage. Some or all stages may include exposure of the slurry to a catalyzing radiant energy so as to polymerize a photoactivable pre-polymer contained in the slurry.

For example, after un-hardened or un-solidified slurry is poured out of the mold in each step, the partially or somewhat hardened or solidified layer of slurry that remained in the mold may be exposed to catalyzing radiant energy to promote hardening thereof. In some examples, such a process may include only one stage in which slurry is disposed in the mold, allowed to harden or solidify somewhat, the unhardened slurry may be removed from the mold, then the remaining slurry exposed to catalyzing radiant energy to stimulate hardening and formation of a green ceramic article. In other examples, this process may be repeated several times, in multiple stages. In some such examples, the constituents of the slurry may differ from one stage to the next, or the exposure to radiant energy may differ from one stage to the next. In addition to variations in coarseness, different photoactivable pre-polymers may be used in different stages, or some stages or a stage may include use of a slurry that contains no photoactivable pre-polymer while other stages or another stage may include use of a slurry that does contain a photoactivable pre-polymer.

In alternative embodiments, a slurry containing a photoactivable pre-polymer may be exposed to catalyzing radiation before or as the slurry is introduced into an opening of the mold. In this way, polymerization of the photoactivable pre-polymer in the slurry can begin before the slurry enters and settles in the mold. In some examples, this slurry can be further exposed to catalyzing radiation after it is introduced into and settles in the mold.

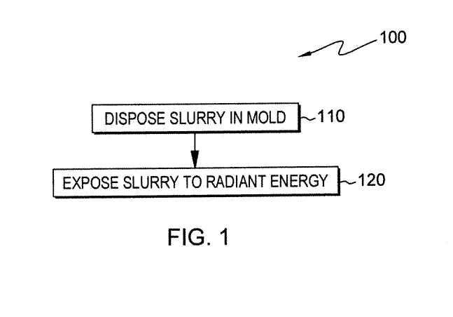

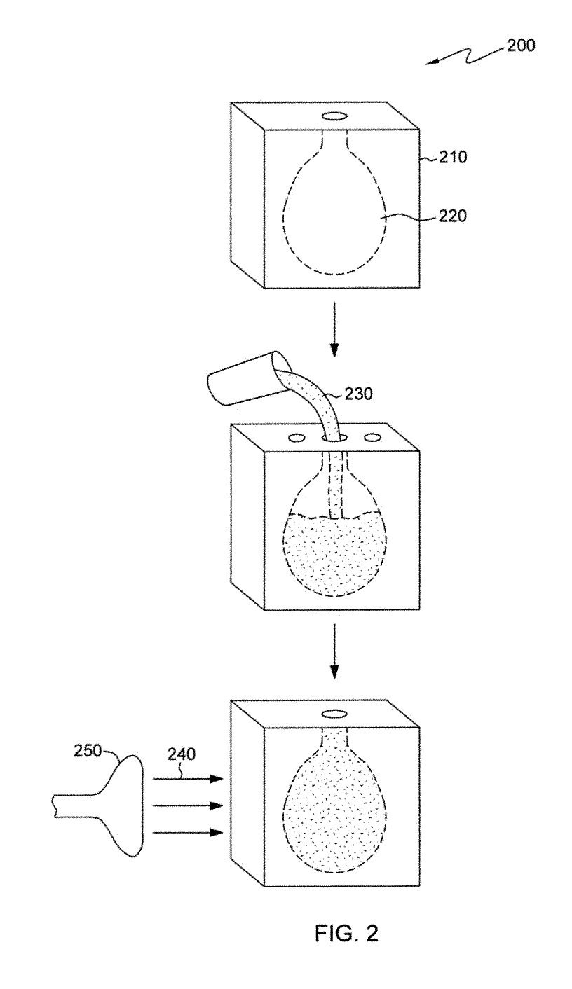

Aspects of the present disclosure are illustrated in the accompanying figures. FIG. 1 is a flow diagram showing a method 100 whereby a slurry containing a photoactivable pre-polymer is disposed in a mold 110 then the slurry, as disposed in the mold, is exposed to radiant energy that catalyzes polymerization of the photoactivable pre-polymer 120. In accordance with aspects of the present disclosure, a slurry may also include a powder or particles, wherein the powder is a ceramic powder or a metallic powder. FIG. 2 illustrates aspects of such a method 200. A mold 210 has a hollowed-out opening 220. A slurry 230 containing a photoactivable pre-polymer is disposed into the hollowed-out opening 220, filling or partially filling said hollowed-out opening. The slurry 230 in the mold 210 is then exposed to catalyzing radiant energy 240 emanating from a radiant energy source 250 (such as a source of catalyzing electromagnetic radiation). In accordance with aspects of the present disclosure, a slurry may also include a powder or particles, wherein the powder is a ceramic powder or a metallic powder.

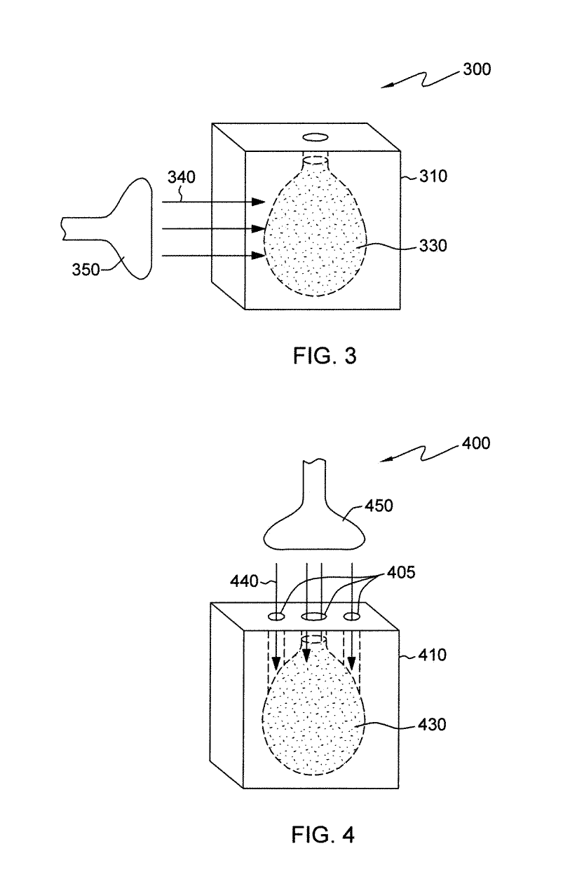

FIG. 3 shows one example of a method in accordance with the present disclosure 300. In this example, the mold 310 is at least partially transparent to the catalyzing radiant energy 340 emanating from the radiant energy source 350. Transparency of the mold 310 to the catalyzing radiant energy 340 enables access of the catalyzing radiant energy 340 to the slurry 330 contained within the mold 310, such that emanation of catalyzing radiant energy 340 from a radiant energy source 350 located outside the mold 310 may result in catalysis of polymerization of the photoactivable pre-polymer in the slurry 330. In accordance with aspects of the present disclosure, a slurry may also include a powder or particles, wherein the powder is a ceramic powder or a metallic powder. In another example 400, illustrated in FIG. 4, there are holes, gaps, or openings 405 in the mold 410. The presence of openings, gaps, or holes 405 in the mold enables access of the catalyzing radiant energy 440 to the slurry 430 contained within the mold 410, such that emanation of catalyzing radiant energy 440 from a radiant energy source 450 located outside the mold 410 may result in catalysis of polymerization of the photoactivable pre-polymer in the slurry 430. In accordance with aspects of the present disclosure, a slurry may also include a powder or particles, wherein the powder is a ceramic powder or a metallic powder.

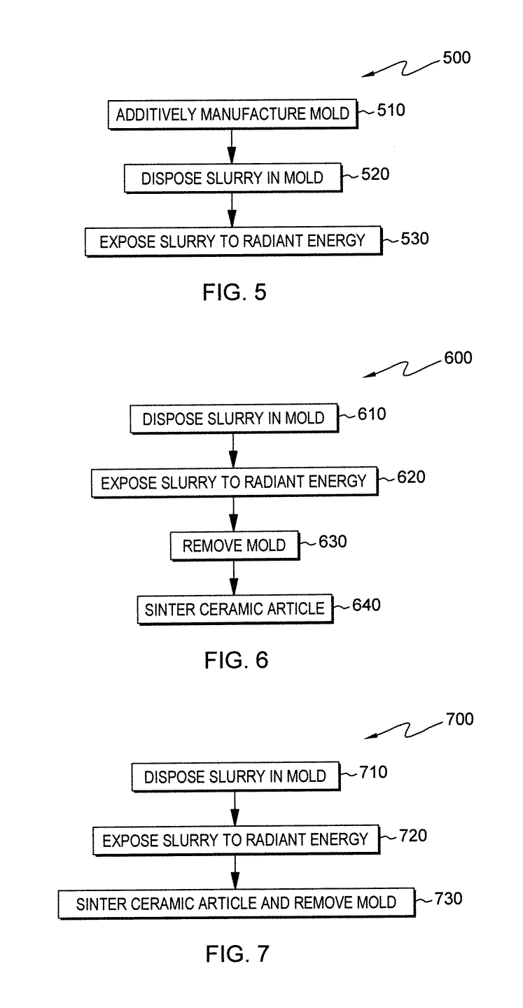

FIG. 5 shows a flow diagram illustrating another example 500 in accordance with the present disclosure. In this example 500, a mold is additively manufactured 510. Slurry, containing a photoactivable pre-polymer, is then disposed in the additively manufactured mold 520, and then exposed to catalyzing radiant energy 530. In accordance with aspects of the present disclosure, a slurry may also include a powder or particles, wherein the powder is a ceramic powder or a metallic powder. FIG. 6 shows another example of a flow diagram 600 in which a slurry containing a photoactivable pre-polymer is disposed in a mold 610. The slurry is then exposed to catalyzing radiant energy 620, leading to formation of an article, such as a green ceramic article, or other article, such as a metal article or unfired, “green” metal article. The mold is then removed 630, such as by being manually removed or being heated to melt or burn away the mold. After the mold is removed 630, the article is sintered 640 to form a finished article such as a ceramic article or metal article. Another example is illustrated in FIG. 7. FIG. 7 shows a flow diagram 700 of a method in which a slurry containing a photoactivable pre-polymer is disposed in a mold 710. The slurry is then exposed to catalyzing radiant energy 720, leading to formation of an article, such as a green ceramic article, or other article, such as a metal article or unfired, “green” metal article. The article is then sintered 730, and the process of sintering the article includes removing the mold, such as by melting or burning the mold away.

### EXAMPLES

Aspects of the present disclosure now will be further illustrated by, but by no means are limited to, the following Examples.

A slurry was formed by mixing 34 grams of FORMLABS liquid investment casting resin, 90 grams of TECO fused silica solids from equal parts (30 grams each) of 325 mesh, 125 mesh, and fused silica. (TECO fused silica is a product of CE MINERALS CORP). to form a finished ceramic article. The slurry contained approximately 72 per cent by weight solid components. The solids were added to the liquid and mixed intensively for about 15 minutes. The slurry was poured in a 3-D printed mold cavity produced from acrylonitrile butadiene styrene (ABS). Mild vibration was applied to the mold to insure filling. The mold with the slurry was exposed to UV light, in the form of sunlight, for approximately one hour. The mold was placed in acetone which dissolved the ABS printed mold. The resulting green ceramic article was very strong and rigid after the mold was completely removed. The green ceramic article was then ready for low temperature and high temperature firing to remove the plastic binder material and to sinter the ceramic particles.

It was discovered that embodiments of the present invention provide results that are unexpected by skilled artisans in the relevant field. The conventional wisdom in the field would not have allowed using a slurry including a photoactivable pre-polymer in a disposable mold of various shapes and sizes since radiant energy may not be able to penetrate into the slurry in the thick portion of the mold. However, it was discovered that the degree of curing of the slurry including a photoactivable pre-polymer in the mold by radiant energy was unexpectedly greater than would have been expected from the conventional wisdom and technology. Moreover, there is also a benefit of not curing completely the inside of the slurry in the thick portion of the mold. In that case, it would be easier to fire the green ceramic article and remove the binder liquid, compared to the completely cured ceramic piece.

There may be additional advantages of using one or more embodiments of the present invention. Unlike gelcasting or setting by chemical reaction, curing by radiant energy (e.g., light or UV curing) does not have a time constraint since the setting will not occur until the slurry is exposed to the specific light or other specific radiant energy. Therefore, if the specific light or the specific radiant energy is absent, then the user can dictate the time allowed to thoroughly mix the material and viscosity of the slurry may be very high. A highly viscous slurry can be poured into a mold under vibration and still fill the mold whereas a chemically set slurry will harden. Accordingly, the range of liquid to solid loading may be large. A high solid loading will yield a part that is easy to fire since the there is little binder liquid to remove.

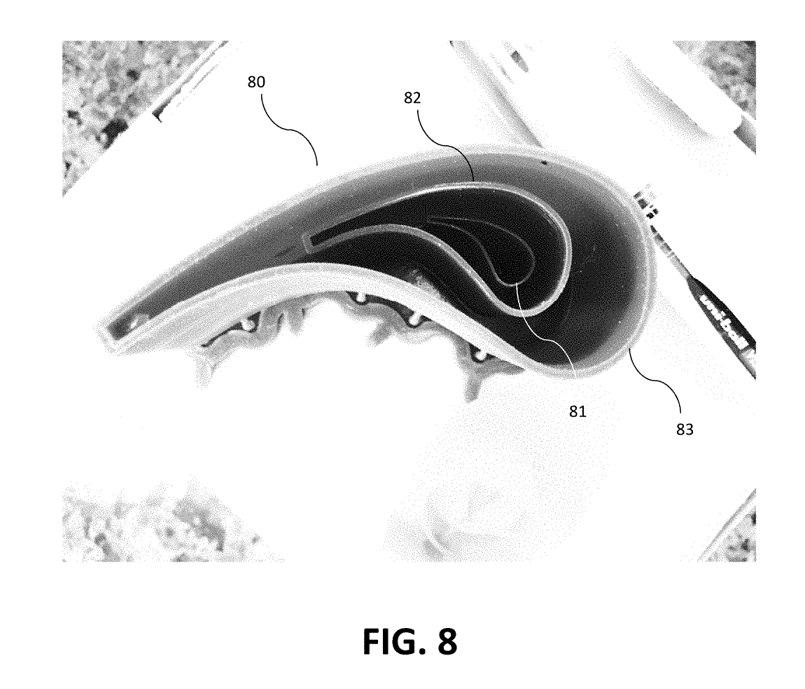

FIG. 8 illustrates a top view of a delicate ceramic piece 80 having a core structure 81 within another core structure 82 within yet another core structure 83 that is formed in accordance with an exemplary embodiment of the present invention. It is difficult to form a ceramic piece having such a delicate and complex inner structure by 3-D printing, gelcasting, or setting by chemical reaction.

While this invention has been described in conjunction with exemplary embodiments outlined above and illustrated in the drawings, it is evident that many alternatives, modifications and variations in form and detail will be apparent to those skilled in the art. Accordingly, the exemplary embodiments of the invention, as set forth above, are intended to be illustrative, not limiting, and the spirit and scope of the present invention is to be construed broadly and limited only by the appended claims, and not by the foregoing specification.

What is claimed is:

1. A method for forming a ceramic article, comprising:
disposing a slurry in a mold, wherein the slurry comprises a ceramic powder and a photoactivable pre-polymer; and
forming a green ceramic article wherein forming comprises exposing the slurry to radiant energy, wherein the radiant energy catalyzes polymerization of the photoactivable pre-polymer.

2. The method according to claim 1, wherein the radiant energy comprises a wavelength and the wavelength is selected from the group consisting of radiofrequency, microwave, infrared, visible, ultraviolet, X-rays, and gamma rays.

3. The method according to claim 1, wherein the radiant energy comprises ultraviolet radiation.

4. The method according to claim 1, wherein exposing occurs until the slurry attains a hardness and the hardness is the maximum hardness that can be caused by exposure to the radiant energy.

5. The method according to claim 1, wherein material comprising the mold is at least partially transparent to the radiant energy.

6. The method according to claim 1, wherein the mold comprises one or more openings and the radiant energy passes through one or more of the one or more openings.

7. The method according to claim 1, wherein the mold comprises a material and the material is selected from the group consisting of acrylonitrile butadiene styrene and polylactic acid.

8. The method according to claim 1, further comprising sintering the green ceramic article to form a sintered ceramic article.

9. The method according to claim 8, comprising removing the mold from the green ceramic article before sintering.

10. The method according to claim 8, wherein sintering comprises removing the mold from the ceramic article during sintering.

11. The method according to claim 10, wherein disposing comprises a process of multi-stage slip pouring.

12. The method according to claim 11, further comprising altering the composition of the slurry between stages of the process of multi-stages slip pouring.

13. The method according to claim 12, wherein the slurry comprises a coarseness, and the coarseness of the slurry disposed at an earlier stage of the process of multi-stage slip pouring is less than the coarseness of the slurry at a later stage of the process of multi-stage slip pouring.

14. The method according to claim 1, further comprising disposing a mold coating on the mold.

15. The method according to claim 14, wherein disposing a mold coating comprises chemical vapor deposition or vapor phase deposition.

16. The method according to claim 1, further comprising manufacturing a mold and manufacturing comprises additive manufacturing.

17. A method for forming an article, comprising:
disposing a slurry in a mold, wherein the slurry comprises a photoactivable prepolymer and a powder and the powder comprises a ceramic powder, a metal powder, or both; and
exposing the slurry to ultraviolet radiation wherein the ultraviolet radiation catalyzes polymerization of the pre-polymer.

18. The method according to claim 17, wherein material comprising the mold is at least partially transparent to the ultraviolet radiation.

19. The method according to claim 18, wherein material comprising the mold is acrylonitrile butadiene styrene.

20. The method according to claim 19, further comprising removing the mold from the article by contacting the mold with a compound that dissolves the mold but does not dissolve the article.
